(19) United States
(12) Patent Application Publication
(10) Pub. No.: US 2006/0101683 A1
(43) Pub. Date: May 18, 2006

(54) Changeable graphic faceplate and method for multi-faced signs and billboards

(76) Inventor: Robert A. Baker, Jonesboro, AR (US)

Correspondence Address: CRUTSINGER & BOOTH, 1601 ELM STREET, SUITE 1950, DALLAS, TX, 752014744, US

(21) Appl. No.: 10/987,619

(22) Filed: Nov. 12, 2004

(51) Int. Cl. G09F 11/02

(52) U.S. Cl. 40/503

(57) ABSTRACT

A faceplate is provided for use in a multi-faced sign having a plurality of louvers, wherein each louver has a plurality of faces and a slot in each of the faces. The faceplate includes: a generally rectangular panel; a rib on the back side of the panel adapted to engage the slot in one of the faces of the louver and retain the panel on the face of the louver; and a groove adjacent each elongated edge of the front side of the panel, wherein each groove is substantially parallel to the front side of the panel and the grooves open toward one another. A method of using the faceplate is also provided, including the step of attaching the faceplate to a face of a louver and the step of attaching a rectangular sheet material to the front side of the panel of the faceplate by inserting the elongated pair of edges of the sheet material to slide between the grooves on the front side of the panel, whereby the sheet material is constrained between the grooves on the front side of the panel.

### TECHNICAL FIELD

The present invention relates to signs and billboards that use multi-faced louvers to enable multiple sign displays, usually three, to be periodically or selectively shown on a single structure.

### BACKGROUND

Advertising signs are a widely used means of passing on advertising messages to the general public. Of particular success are sign displays that use a plurality of sign elements in the general shape of triangular prisms to enable three billboard type displays to be periodically or sequentially shown on a single structure.

The triangular prism segments, referred to in the art by various names such as “display elements” or “louvers”, are adapted for rotation about parallel axes, whereby predetermined ones of the plurality of faces of each display element can be aligned in co-planar relationship to produce a substantially complete image. By this means, for example, three different signs can be displayed by rotation of the triangular display elements and alignment of the display surfaces. In addition, the rotation of the display elements helps attract attention to the sign or billboard.

Typical mechanical signs, however, have experienced many problems. For example, the changing of the graphics has been costly and time consuming. Over the years, many designs have been tried to improve the reliability and reduce maintenance costs associated with this kind of sign, however, problems with reliability and maintenance have continued to plague the industry. In addition, various efforts have been made to reduce the difficulty and expense in changing the graphic advertisement or message on this type of sign.

U.S. Pat. No. 1,461,047 entitled “Advertising Sign” filed May 25, 1920 having for named inventor Joseph L. Ray discloses an advertising sign having a permanent frame indicated at a, supported on suitable standards b. In the supporting standards b for the frame, or in any other desired relation thereto, is supported a rotatable shaft d on which may be keyed a series of gear wheels e on each of which is bolted a gear segment f. The segment f may be carried by a bolt f′ adapted to be moved adjustably in a segmental slot e′ cut in each of the wheels e. The shaft d is geared operatively to a prime mover g by which rotation is imparted to each of the gear wheels e.

U.S. Pat. No. 3,199,239 entitled “Rotatable Indicia-Bearing Vanes for Signboards” issued Aug. 10, 1965 and having for named inventor Theodore M. Reed discloses a rotatable plural-faceted vane for use in plural message signboards with each vane comprising a rotatable core having a plurality of core faces or panels that define an elongate prison. A plurality of securing means releasably hold a plurality of indicia bearing facet panels adjacent a core face. There are as many facet panels as there are core faces. The securing means orient the facet panels so that they abut edge to edge to define a hollow prism about the elongate core prism that is geometrically similar to the core prism. Conventionally, the prisms defined are triangular in cross-section.

French Patent No. 1,390,194 entitled “Dispositif publicitaire comprenant plusiers prismes triangulaires disposes cotes a cote” issued Jan. 18, 1965 discloses a sign having rotating triangular prisms. It appears that graphics material is inserted and maintained on the surfaces of the prisms behind transparent envelopes.

U.S. Pat. No. 3,304,638 entitled “Activated Changeable Advertising Sign” issued Feb. 21, 1967 and having for named inventors William A. Grandell, James M. Wasson, and Richard Z. Wasson discloses an advertising sign having louvers with different display bearing surfaces. Sign letters are applied or painted or physically attached upon the respective 3 faces of the louvers so that any desired sign, either letters, words, or pictures, may be applied to the three flat faces of said louvers in a way that when any of matching faces are presented to a forward parallel plane, the desired message or picture will be visible.

U.S. Pat. No. 3,313,131 entitled “Louvered Sign Construction” issued Apr. 11, 1967 and having for named inventor Willy T. Werner discloses a louvered type of signboard in which polygonal shaped vertically extending members are rotated and indexed in such a way that a plurality of different advertising message may be sequentially displayed in a single sign location. Each louver has a transparent or translucent cover that has bent edges that form flanges for engagement with slots at the elongate edges between the panels of the louvers. A paper or cardboard strip carrying part of the advertising message will be seen through the cover, the strip overlaying the panel.

U.S. Pat. No. 3,387,394 entitled “Sign Construction” issued Jun. 11, 1968 having for named inventor Willy T. Werner discloses a display sign of the type in which three different advertising messages are presented in sequence by rotation of a plurality of three-sided louvers. Panels are secured to core members to make up the louvers by means of brackets and clips which secure these members together upon relative movement in one direction. A lock between the core members and panels prevents movement in a direction permitting disengagement. A spring biased pin carried by the louvers snaps into engagement with a frame to rotatably support the upper end of the louvers.

U.S. Pat. No. 3,826,027 entitled “Multi-Faced Display Sign” issued Jul. 30, 1974 and having for named inventor Pieter Abbema discloses a display sign which has a plurality of endless strings of planar elements. An element of one string cooperates with corresponding elements of the strings to form an advertising or other display panel when such elements are placed side by side in a common frontal plane. The strings of elements are supported by vertically disposed shafts which are synchronously rotated to bring the elements into proper alignment.

U.S. Pat. No. 3,983,648 entitled “Changeable Message Sign with Gap Closure Apparatus” issued Oct. 5, 1976 and having for named inventor E. Tait Hunter, Jr. discloses sign apparatus having a message display space, a number of message support elements which are movably positionable within the message display space, and apparatus for automatically closing gaps which occur in the message display space when the message support elements are repositioned. The message support elements are periodically rotated to change the message appearing in the message display space, and gap closure elements are operatively interconnected with the message support elements to occupy gaps which would otherwise be visible in the message display space due to the offset message support faces on the message support elements. Several embodiments of the present sign apparatus are disclosed.

U.S. Pat. No. 4,021,946 entitled “Multielement Changeable Sign Display” issued May 10, 1977 having for named inventor James T. Bradshaw discloses a sign display comprising a plurality of triangular display elements each having three display surfaces. The display elements are arranged along mutually perpendicular sets of axes to define a matrix display having a display pane. Rotary drive shafts extend through the display elements parallel to the display surfaces, and each display element includes a clutch structure comprising frustoconical clutch members received in frustoconical apertures formed in the display element and spring biased to be normally coupled to the display element for rotation with the drive shaft extending therethrough. Abutment surfaces corresponding to the display surfaces project from the lower end of each display element for selective actuation to terminate rotation of the display element with a predetermined display surface situated in the display pane. The first display surfaces of all of the display elements may be utilized in combination to form a dedicated sign, and the second and third display surfaces of each display element may comprise contrasting colors, in which case the second and third surfaces of the display elements are utilized to form a desired sign by means of a matrix display.

U.S. Pat. No. 4,060,920 entitled “Signboard” issued Dec. 6, 1977 and having for named inventor Lindell N. Edwards discloses a signboard which is tubular in configuration has elongated grooves in the surface thereof that can accommodate the resilient clips of indicia. That signboard occupies only a limited amount of floor space when it is mounted with its axis vertical; and the elongated grooves in the surface of that signboard facilitate the positioning of indicia at levels at which that indicia is readily visible.

U.S. Pat. No. 4,189,859 entitled “Device at Display Arrangement” issued Feb. 26, 1980 having for named inventor Stig B. Ahlgren discloses a display having a frame and prisms rotatably mounted therein, each of the prisms including adjacent longitudinally extending side surfaces so that each set of associated side surfaces of the prisms provides a display when rotated to a side-by-side position defining a permanently recurring sequence with the number of displays corresponding to the number of side surfaces on each prism. Each prism is provided with a pair of rotation axles disposed at opposite ends thereof. A drive motor and a transmission rotate the prisms synchronously, the drive motor being connected to one of the rotation axles. Gear discs are mounted on one rotation axle of each pair provided on the prisms with at least one belt mounted on the gear discs for rotating the gear discs and the prisms when one rotation axle is output by the drive motor, the belt being toothed for meshing with the gear disks.

United Kingdom Patent No. 2105895B entitled “Display Apparatus” issued May 30, 1985 and having for named inventor Anthony James Singleton discloses a display device having at least one display member which has two or more elongate sides and is mounted for rotation between positions in which different display sides are displayed, and wherein said display sides are provided by front faces of individually detachable elongate display panels, each said panel having mounting means at longitudinally spaced regions, which are detachably engageable with respective complementary mounting means of the display member to retain the panel on the member in a configuration in which its display side is displayable; engagement of each complementary pair of mounting means comprising insertion of a projection into complementary receiving means, the arrangement being such that a panel is detachable by displacement in one longitudinal direction until the first said projection is freed from its receiving means, the second projection being relatively moved by the displacement into deeper engagement with its receiving means; and subsequent displacement of the panel in the opposite longitudinal direction to free the second projection.

U.S. Pat. No. 4,528,763 entitled “Sign Having Changeable Displays” issued Jul. 16, 1985 and having for named inventor Stig B. Ahlgren claiming a sign formed from plural trilateral display screen assemblies, each assembly being rotatable to dispose one of three screen sides in a forward position, wherein all corresponding screen sides in such forward position collectively defining and displaying a picture.

U.S. Design Pat. No. 281,336 issued Nov. 12, 1985 and having for named inventor Stig B. Ahlgren discloses and is entitled a “Rotatable Display Element for Changeable Message Sign.”

U.S. Pat. No. 4,638,580 entitled “Publicity Board with Rotating Prismatic Members” issued Jan. 27, 1987 and having named inventors Anna Giannetti, Sergio Massa, and Cesare Re that discloses a publicity board provided with a plurality of rotatable prismatic members mounted side-by-side, each being arranged to carry portions of publicity images on its faces, and further provided with a meter for rotating the prismatic members about their respective longitudinal axes. The motor is coupled to the prismatic members by means of an operating shaft driven by the motor and carrying a plurality of radial rods such that they rotate, to each cooperate with respective appendices extending radially from an end pivot of each prismatic member, for the purpose of transmitting to this latter a rotation through an angle which is double the angle formed at the center by each face of said prismatic member.

U.S. Pat. No. 4,676,767 entitled “Driving Device for Signs” issued Jun. 30, 1989 and having for named inventor Stig B. Ahlgren discloses a driving device for signs having movable display screens which are multi-lateral and simultaneously rotatable by means of a driving unit for providing a number of continuously recurrent pictures corresponding to the number of sides on the display screens. Some of the display screens comprise two toothed pulleys of which one is adapted to cooperate with a toothed belt for transferring the driving power of the driving unit from a preceding display screen. The other pulley is adapted to cooperate with another toothed belt for transferring the driving power to a succeeding display screen. In order to facilitate setting of the display screens relative to each other by tightening and loosening of said toothed pulleys and by preventing toothed pulleys for the same display screen from rotating relative to each other during setting, both toothed pulleys for the display screen form part of a toothed twin-pulley as toothed portions which are fixedly connected to each other. The toothed twin-pulley further comprises a clamping device with clamping members positioned axially outsides the toothed portions. At least one clamping means is provided on the clamping members and extends transversely to the axis of rotation of the toothed twin-pulley for tightening to clamp the clamping device on a shaft journal on the display screen.

French Patent Publication No. 2,630,849 published Nov. 3, 1989 discloses a triangular display unit that rotates about its vertical axis. An advertising panel is fixed to each face and may contain a part-message with each section being displayed to the viewer in turn. Each face is recessed. A sheet of fixing hooks is fixed in each recess. The back of each display panel has the complementary sheet of loops on the rear surface.

International Patent Application No. WO 89/08303 entitled “Advertising Device” published Sep. 8, 1989 and having for named inventors Stephan Mack and Hannspeter Grieskamp claiming an advertising device is composed of several adjacent image elements that are able to rotate around their longitudinal axes. Each individual image element carries on each side an image carrier which received a longitudinal strip of the whole advertising image. The cross-section of the image carrier has essentially the form of a box provided with an opening on the side facing the image element. A leaf spring is fastened with rivets to the image element. The image carrier bears with its opening against the free end of the leaf spring, so that latter can ingress into the box. The image carrier then slides downwards until it reaches a stop, and the leaf spring holds it immovably on the inner side of the box. The assembly is dismounted in the reverse order. It, thus, becomes possible to easily exchange image carriers and to replace them on the spot by new, already prepared image carriers.

International Patent Application No. WO 92/11621 entitled “Improved Multi-Message Sign” published Jul. 9, 1992 and having for named inventors Paul Bergeron and David Wood claiming a sign providing for the serial display of three discrete messages is disclosed. The disclosed sign has an array of discrete vertical three-sided sign elements provided with an improved sign element mounts and bearings, improved detachable face plates for the display of the three sign messages, and an improved sign element drive for simultaneous rotation of the sign element array in 120° increments for sequential display of the three discrete messages of the sign.

U.S. Pat. No. 5,136,799 entitled “Automatic Open and Close Sign” issued Aug. 11, 1992 and having for named inventors Alvin Knappick and George Spector discloses an automatic and manually operated open-closed sign is provided that will include a timed motor to operate rotatable slats having the words “OPEN” and “CLOSED” printed on each side. A manual override is also provided so that the sign can be operated directly by a person.

U.S. Pat. No. 5,161,421 entitled “Driving device for driving or operating elongate display members at signs for consecutive, repeated presentation of series of images” issued Nov. 10, 1992 and having named inventor Stig E. A. Stigsson discloses a driving device for driving or operating elongate display members at signs for consecutive, repeated presentation of series of images, whereby said elongate display members are driven through pairs of gear wheels having conical teeth and whereby a driving gear wheel in each pair of gear wheels is provided on a drive shaft and a driven gear wheel in each pair is operatively connected with the elongate display member to be driven. In this driving device, for being able to rotate the driving unit forming part thereof continuously in one and same direction of rotation and to ensure that the elongate display members can not come “out of phase” neither during rotation nor when they stand still in their display positions, the driving gear wheel comprises a gear sector which occupies only a part of the periphery of said driving gear wheel such that said driving gear wheel, is in driving engagement with the driven gear wheel only during a part of a revolution of said driving gear wheel and the drive shaft has a lock which is provided to cooperate with said driven gear wheel or with members non-rotatably connected therewith in such a manner that said driven gear wheel is blocked against rotation during that part of the revolution of said driving gear wheel when the gear sector of said driving gear wheel is out of driving engagement with the teeth of said driven gear wheel.

U.S. Pat. No. 5,255,463 entitled “Rotating Sign Assembly” issued Oct. 26, 1993 having for named inventor Paul H. Werner discloses a rotating sign assembly including a number of multi-sided, rotatable sign segments output by an elongated drive shaft operably interconnected with each of the sign segments. The drive shaft includes at least one multi-armed output cam fitted to the drive shaft. Each arm of the output cam includes an outer sloped driving surface and a peaked extremity. The output cam is rotatably output by a driving arm assembly comprising a driving pin plate and an output arm stop plate. The driving pin plate includes a pair of pins, one situated on each end of the plate. Each driving pin alternatingly interacts with the outer sloped surfaces of the cam for rotation thereof, this rotation being halted by interaction of the peaked extremities alternatingly with the ends of the stop plate.

U.S. Pat. No. 5,255,465 entitled “Multiple Display Sign Assembly” issued Oct. 26, 1993 having for named inventor Hector Perez discloses a multi-display sign assembly including a frame structure having a pair of support bars, and a plurality of elongated, lightweight triangular members rotatably held between the support bars by axle bars which extend longitudinally through the triangular members and protrude through the support bars. A motor is connected to a reducer which regulates the RPM's of a drive gear connected thereto, the drive gear including teeth only along 120 degrees of its exterior surface such that, when the teeth engage a secondary gear which is connected to the axle bar of one of the triangle members, that triangle member will rotate resulting in a new display face of all the triangle members rotating to form a new one of three distinct display surfaces containing advertising or like indicia thereon.

U.S. Pat. No. 5,259,135 entitled “Display Device” issued Nov. 9, 1993 and having for named inventors Brian C. Bannister, James N. Morgan, Simon A. Rivers-Bland, and David Duncan discloses an improved mode of construction is provided for a display device of the kind comprising an array of triangular-section slats rotated in synchronism in 120° steps to present repeatedly to view, in sequence, three compound display surfaces, each carrying a respective poster or the like. In embodiments of the invention, each slat has a respective bearing and driving module with a respective rotary members releasably drivingly engaging the slat and with a respective cam, driving the rotary member and driven in turn by a driving shaft, passing through the cams of the bearing and driving modules of all of the slats. The bearing and driving modules are received in a stack within a hollow extrusion which forms one side member of a frame of the display device. The opposite side member of the frame receives a stack of bearing members rotatably supporting the opposite ends of the respective slats.

U.S. Pat. No. 5,511,330 entitled “Louver Sign Transmission System” issued Apr. 30, 1996 having for named inventor Dale I. Havens discloses a transmission system for louver type signs wherein the signs consist of a plurality of multiple faced louvers having indicia defined thereon, and the side-by-side relationship of the louvers permits pre-selected faces to define a completed image and simultaneous partial rotation of the louvers presents a new visible image, and wherein each louver is operated by a separate “T” drive bevel gear transmission having an output shaft upon which a louver is mounted operatively connected to a drive shaft perpendicularly related to the output shaft. The drive shafts of adjacent transmissions are interconnected, and a plurality of transmissions are simultaneously operated by a single motor drive source.

U.S. Pat. No. 5,806,221 entitled “Drive For A Multi-Sided Display Sign” issued Sep. 15, 1998 having for named inventor Loren L. Vander Woude discloses a segmented sign drive that provides rotational driving force from a drive arm moving in reciprocating motion. The arm moves a series of pins in a series of grooves located in drive disks. A drive disk is mounted to each segment of the sign so as to rotate the segments into preferred positions in a step-by-step sequence where all of the segments move together to new positions so as to change the outward appearance of the sign. The grooves are ramped so that, on a forward stroke of the drive arm, the pins are moved upward on a ramped groove in the drive disks to fall into a preferred hole at one end of each of the grooves. On the return or reverse stroke, the pins, now caught within the holes, cause the disks to rotate by one part of the cycle. On the next cycle, the pins again move out of the holes and up the ramp surfaces of the next grooves which have been moved into place where the former grooves were. In this manner, the disks are caused to rotate by an appropriate amount on each rotational cycle of a switch limited motor.

U.S. Pat. No. 5,933,990 entitled “Rotatable Sign” issued Aug. 10, 1999 and having for named inventors William W. Keyser and David B. Keyers discloses a rotatable sign with a plurality of routinely alterable display faces is disclosed, having at least two endless roller chains, a plurality of mounting clips and bi-ended slats, and a plurality of interchangeable message strips and flexible sheets that may be mounted on the sign assembly using the slats and clips, where portions of the message strips may be altered using self-stick adhesive patches.

U.S. Pat. No. 6,065,232 entitled “Multiple Display System” issued May 23, 2000 and having for named inventors Charles S. Haughey, Peter D. Young, and Stephen A. Gelnett discloses an apparatus for controlling a drive mechanism of a panel display system includes a rotary member attached to a drive assembly, the rotary member having indicators located at known intervals that are detected to ensure that the drive assembly starts and stops at precise locations. In a preferred embodiment, the control system is applied to a panel display system that displays different scenes using an array of elongated three-sided display elements. The preferred control system includes an aluminum disk that is attached to rotate in connection with rotation of the drive assembly.

U.S. Pat. No. 6,038,799 entitled “Indexing System For Changeable Signs” issued Mar. 21, 2000 and having for named inventors Dale I. Havens and Michael R. Atkinson discloses an indexing system for signs consisting of a plurality of indicia bearing vane faces wherein the vane faces are sequentially exposed to view in the manner of a “wave”, such sequential revealing of the sign vane faces generating interest in the sign's message. Each sign vane is rotated by a transmission, and the transmissions are interconnected in such a manner as to sequentially operate the vanes to produce the “wave” action and detents associated with each transmission lock the sign vane in the desired position.

U.S. Pat. No. 6,065,232 entitled “Multiple Display System” issued May 23, 2000 having for named inventors Charles S. Haughey et al. discloses an apparatus for controlling a drive mechanism of a panel display system that includes a rotary member attached to a drive assembly, the rotary member having indicators located at known intervals that are detected to ensure that the drive assembly starts and stops at precise locations. In a preferred embodiment, the control system is applied to a panel display system that displays different scenes using an array of elongated three-sided display elements. The preferred control system includes an aluminum disk that is attached to rotate in connection with rotation of the drive assembly.

U.S. Pat. No. 6,128,841 entitled “Drive Mechanism for Picture Sign” issued Oct. 10, 2000 having for named inventor Paul H. Werner discloses a rotating sign assembly having a plurality of rotatable, multi-sided, sign segments and a drive mechanism for rotatably driving the sign segments. The drive mechanism includes a drive shaft and one or more output shafts that each operate to rotate a multi-sided sign segment. A cam is fitted to each of the output shafts so that rotation of the cam causes rotation of the corresponding output shaft and sign segment. The cam has an outer perimeter and multiple equally spaced engagement slots which extend radially inwardly from the outer perimeter. Outwardly facing stabilizing portions are positioned between each of the engagement slots. The cam has multiple dwell positions, each corresponding to the display of one side of the multi-sided sign segment operated by the corresponding output shaft. A cam driver assembly is fitted to the drive shaft so that it rotates with the drive shaft. The cam driver assembly has a cam driver which extends outwardly from the axis of rotation and terminates in a knob. The knob describes an arc as the cam driver is rotated about the axis of rotation. The cam driver is configured to engage one of the engagement slots when the cam is in a dwell position and to rotate the cam to another dwell position as the cam driver assembly is rotated about its axis of rotation. The cam driver assembly also includes a stabilizing member which is configured to engage one of the stabilizing portions of the cam when the cam is in a dwell position.

U.S. Pat. No. 6,295,882 entitled “Device for Operating Display Members at Signs” issued Oct. 2, 2001 having for named inventor Jonas O. Osterberg discloses a device for operating display members at signs for consecutive, repeated presentation of series of images, wherein the members are operated by a driving gear wheel on a drive shaft through a driven gear wheel for each member. The drive shaft has a lock cooperating with a member being non-rotatably connected with the driven gear wheel for setting in a locking position for blocking the driven gear wheel against rotation when no engagement between the gear wheels is present, and leaving its locking position for permitting rotation of the driven gear wheel before engagement once again is present. The lock comprises a first lock member which in locking position cooperates with one of the side surfaces on the non-rotatable member for blocking the driven gear wheel against rotation and preventing displacement of the gear wheels relative to each other in one direction along the longitudinal direction of the drive shaft, and at least one second lock member for at least preventing displacement of the gear wheels relative to each other in at lest the opposite direction along the longitudinal direction of the drive shaft.

As can be seen from the range of different efforts disclosed in these patents of the prior art, there has been a long-felt need for improved systems for multi-faced signs.

### SUMMARY OF THE INVENTION

A faceplate is provided for use in a multi-faced sign having a plurality of louvers, wherein each louver has a plurality of faces and a slot in each of the faces. The faceplate includes: a generally rectangular panel; a rib on the back side of the panel adapted to engage the slot in one of the faces of the louver and retain the panel on the face of the louver; and a groove adjacent each elongated edge of the front side of the panel, wherein each groove is substantially parallel to the front side of the panel and the grooves open toward one another.

A method of using the faceplate is also provided, including the step of attaching the faceplate to a face of a louver and the step of attaching a rectangular sheet material to the front side of the panel of the faceplate by inserting the elongated pair of edges of the sheet material to slide between the grooves on the front side of the panel, whereby the sheet material is constrained between the grooves on the front side of the panel.

These and other aspects and advantages of the invention will become apparent to persons skilled in the art from the following drawings and detailed description of presently most-preferred embodiments of the invention.

### BRIEF DESCRIPTION OF THE DRAWING

The accompanying views of the drawing are incorporated into and form a part of the specification to illustrate several aspects and examples of the present invention, wherein like reference numbers refer to like parts throughout the figures of the drawing. These figures together with the description serve to explain the general principles of the invention. The figures are only for the purpose of illustrating preferred and alternative examples of how the various aspects of the invention can be made and used and are not to be construed as limiting the invention to only the illustrated and described examples. The various advantages and features of the various aspects of the present invention will be apparent from a consideration of the drawings.

FIG. 1 is a perspective view of a multi-faced billboard sign in a typical vertical orientation to the ground, the sign having a frame, a plurality of multi-faced louvers rotationally supported in the frame, a drive motor, and a drive transmission system for periodically rotating the louvers.

FIG. 2 is an exploded perspective view of an example of the major parts of a common type of a prismatic louver having three substantially planar faces, wherein the louver is rotationally supported in a sign by a lower end cap and an upper bushing.

FIG. 3 is a perspective view illustrating a prior art changeable face panel.

FIG. 4 is a perspective view illustrating a faceplate according to the presently most preferred embodiment of the invention positioned adjacent to a conventional louver of the type shown in FIG. 2 for being mounted to (or after being removed from) a face of the louver.

FIG. 5 is a cross-section view of a faceplate according to the presently most-preferred embodiment of the invention, as shown in FIG. 4.

FIG. 6 is an exploded perspective view illustrating a louver as shown in FIG. 2 having one faceplate according to the invention mounted thereon and two additional faceplates according to the invention oriented for attaching to the other two faces of the louver, respectively.

FIG. 7 is a perspective view illustrating three faceplates, each according to the presently most-preferred embodiment of the invention as shown in FIG. 4 having been attached to the faces of a conventional louver of the type shown in FIG. 2, and further illustrating a rolled-up sheet of generally rectangular sheet material positioned to be installed onto one of the faceplates according to a presently most-preferred method of the invention.

FIG. 8 is a perspective view similar to FIG. 7 illustrating the rolled-up sheet of sheet material being installed onto one of the faceplates according to the presently most-preferred method of the invention.

FIG. 9 is a perspective view of an endcap according to the presently most-preferred embodiment of the invention, wherein the endcap is provided with a lip adjacent a lower edge thereof to support the sheet material when a faceplate on a louver is vertically positioned, wherein the endcap is shown mounted for driving rotation.

FIG. 10 is a perspective view of the lower end of a louver according to the presently most-preferred embodiment of the invention positioned on the endcap shown in FIG. 9.

FIG. 11 is a perspective view of a lower, right-hand corner of a multi-faced billboard sign in a typical vertical orientation to the ground, similar to the sign shown in FIG. 1, illustrating the exposed lower lip on each of the plurality the endcaps.

FIG. 12 is a perspective view of an alternative embodiment of a faceplate according to the invention, wherein the lower edge of a faceplate has at least one opening therein for use in attaching a lip structure to a lower edge of the faceplate to support the sheet material when a faceplate on a louver is vertically positioned. For example, all that would be required to provide a lip structure would be one or more rivets to provide an outwardly or forwardly protruding structure against which the sheet material can be supported.

### DETAILED DESCRIPTION OF THE PRESENTLY MOST-PREFERRED EMBODIMENT AND BEST MODE

As used herein, the word “billboard” refers to a large sign, typically a large format sign for outdoors. The preferred embodiments of various aspects of this invention are particularly adapted to be able to be used in “large format” outdoor billboard displays. For example, our present expectation is that this design will work well in a large format sign up to a typical size used in the United States had a display area of fourteen (14) feet tall and forty-eight (48) feet long (not including any frame or support structure).

It is to be understood that, unless expressly noted, relational terms such as “vertical”, “horizontal”, “bottom”, “top”, “lower”, “upper”, “front”, “back”, “side”, “left”, “right”, etc. are arbitrarily assigned for convenient reference to the orientation and perspective of the figures of the drawing or as would normally be understood in usage. For the sake of consistency of usage, once a term is first arbitrarily assigned for reference to a structure in a particular figure, the term will then be used consistently to refer to like parts throughout the other figures of the drawing, even if the orientation of a structure shown in another figure is different for the purpose of showing another feature of the preferred embodiment(s) of the invention. It is to be understood that, unless the context otherwise requires, the use of such arbitrarily-assigned relational or relative terms is not to be construed as unnecessarily limiting the invention.

As used herein and in the claims, the words “comprises” and “includes” are each intended to have an open, non-limiting meaning that does not exclude additional elements or parts of an assembly, subassembly, or structural element.

Unless otherwise expressly stated, the words used in this disclosure and the claims are intended to have their broadest ordinary meaning to persons of skill in the art. First and foremost, the possible definitions of the words used herein are intended to be interpreted by reference to comprehensive general dictionaries of the English language published before or about the time of the filing of the application for patent. Where multiple ordinary definitions are available, the definitions or senses are intended to be selected according to the broadest sense or senses that are not inconsistent with the description of the presently most-preferred embodiments of the invention, including without limitation as shown in the drawings herein. After consulting such general dictionaries, it is intended that the words be further defined or the most appropriate definition or definitions be selected by consulting engineering dictionaries, encyclopedias, treatises, and relevant prior art to which this invention pertains, including, for example, the prior art discussed in the background section. It is intended that, by examining relevant dictionaries, encyclopedias, treatises, and prior art to ascertain possible meanings that can be attributed to the words of the description and claims by those skilled in the art, and by further utilizing the record to select from those possible meanings, the definition or definitions not inconsistent with the use of the words herein, the intended full breadth of the words and terms will be more accurately determined and the improper importation of unintended limitations from the written description into the claims will be more easily avoided.

It should also be understood that the function of a single structure described herein can sometimes be performed by more than one part, or the functions of two different structures can be performed by a single or integrally-formed part. Especially from a manufacturing perspective, it is highly preferred to design the storage device to minimize the total number of parts required to manufacture the storage device. It is not only the costs associated with making additional parts, but also the costs of assembly. Preferably, the fewest possible number of steps and manipulations required to assemble the apparatus, the better.

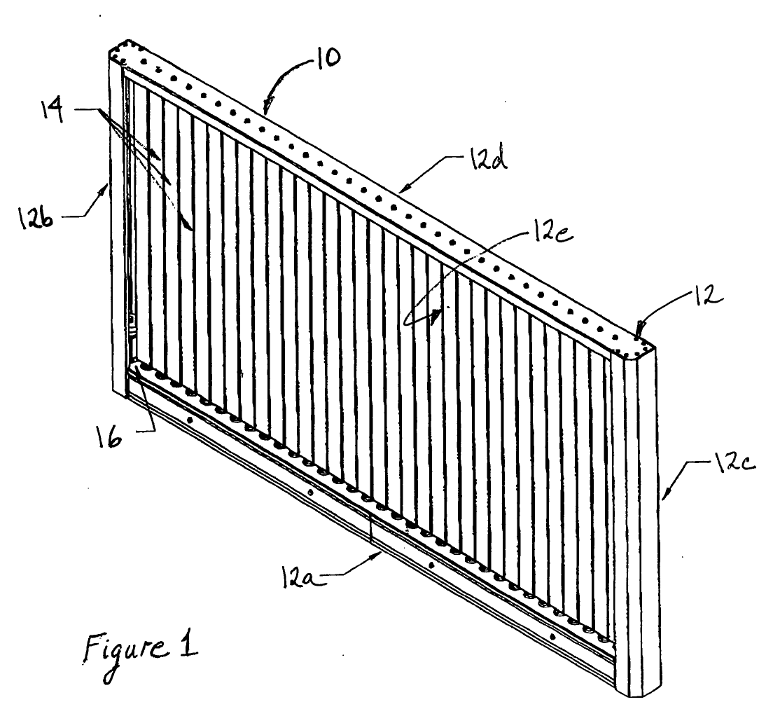

Referring now to the drawing, FIG. 1 is a perspective view of a multi-faced billboard sign 10. The sign 10 has a frame 12, preferably including a bottom 12a, sides 12b and 12c, and top 12d. The frame 12 defines a window 12e in the front of the sign. A plurality of louvers 14 are supported by the frame 12 in a row, where each of the louvers 14: (i) defines a plurality of faces (only one of which is shown in FIG. 1); and (ii) is rotationally supported adjacent another one of the louvers; where the plurality of louvers can be selectively rotated to align one display face of each of the louvers in a co-planar relationship to form a substantially planar display, whereby the plurality of louvers can selectively display one of a plurality of displays (not illustrated) in the window 12e. The sign 10 is shown with the louvers 14 in a typical vertical orientation to the ground, but it is to be understood that the louvers could be horizontally or otherwise oriented as desired.

The sign 10 includes a drive motor 16 supported by the frame 12. As well known in the art, a drive transmission system (not clearly visible in FIG. 1) for periodically rotating the louvers 14 is enclosed in the frame 12, preferably in the bottom 12a of the frame 12. Various drive and transmission systems are illustrated in the patents cited in the background, including without limitation, the motor and gear designs illustrated in U.S. Pat. Nos. 3,313,131; 5,161,421; 5,511,330; 5,806,221; 6,038,799; 6,128,841; and 6,295,882, each of which patents is incorporated by reference herein in its entirety.

Preferably, each of the louvers 14 is a generally triangular prism with three display faces. Each of the louvers is rotated 120 degrees to display a different face. It is to be understood, of course, that the louvers can have only two faces or four or more faces.

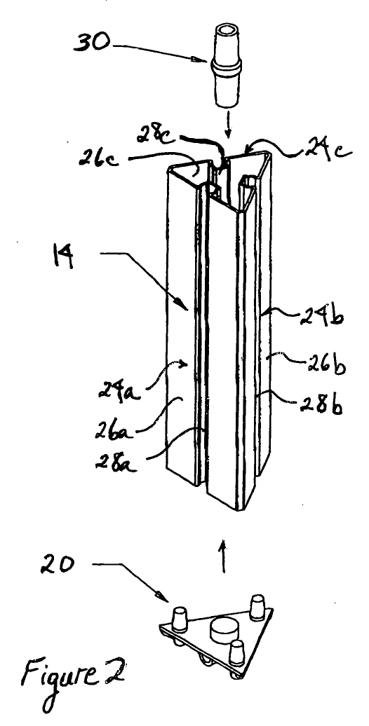

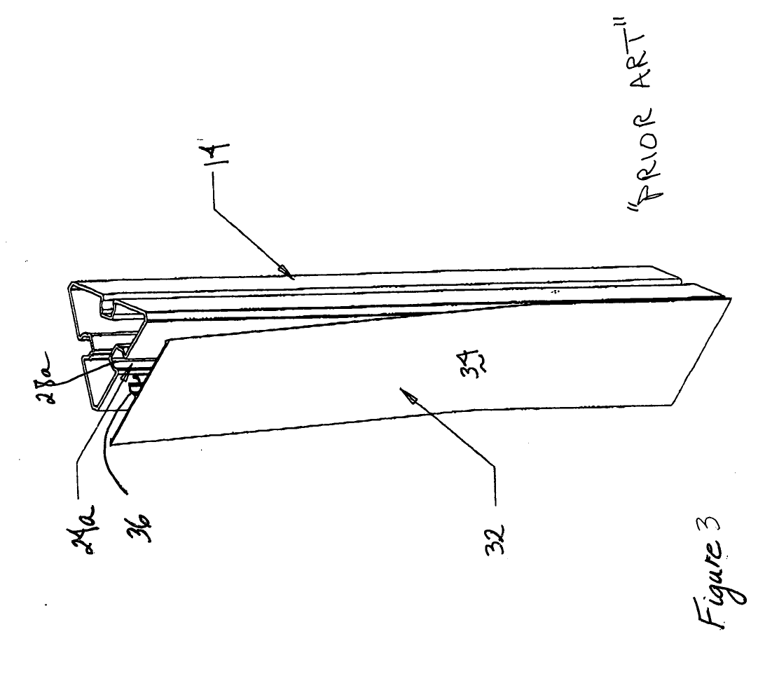

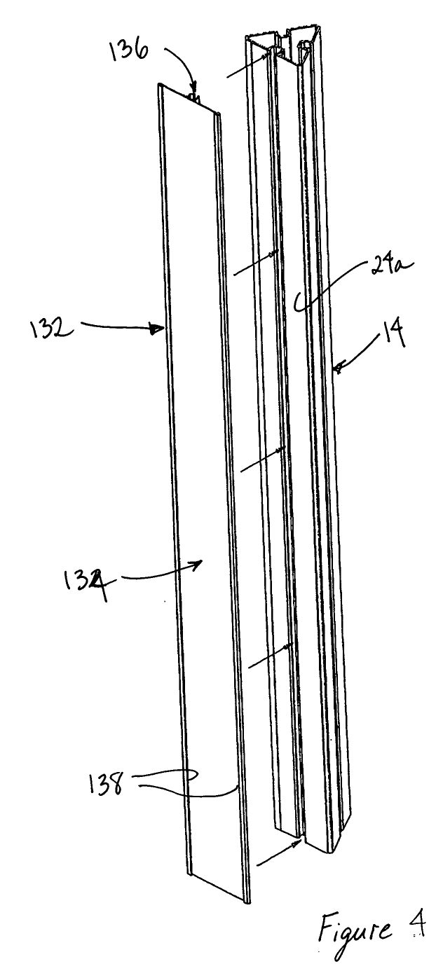

FIG. 2 is an exploded perspective of an example of the major parts of one type of a prismatic louver 14. The louver 14 has three faces 24a, 24b, and 24c adapted for receiving and supporting changeable faceplates (not shown in FIG. 3, but which will be described in detail with reference to FIGS. 3 and 4). Each of the faces 24a, 24b, and 24c preferably comprises a support backing 26a, 26b, and 26c, respectively, and a slot 28a, 28b, and 28c, respectively. Typically, the slot is centrally located in each face of the louver 14. Continuing to refer now to FIG. 2, the louver 14 is rotationally supported by a lower endcap 20 and an upper bushing 30, in a manner well known to those skilled in the art.

FIG. 3 is a perspective view of a louver of the type shown in FIG. 2 illustrating a changeable face panel 32 according to the prior art, which in the process of being mounted to or removed from one of the faces 24a of the prismatic louver 14. The changeable face panel 32 provides a display face 34 and has a rib 36 extending longitudinally along its back for engaging the snap-in slot of the face 24a. This allows the strips of a printed sign image to be remotely applied to the display faces 34 of a plurality of changeable face panels 32, then brought to the site of the sign, a plurality of old changeable display panels to be quickly removed from the prismatic louver 14 of the sign, and then the different plurality of changeable display panels 32 can be quickly and easily snapped into place on the louvers 14, in a manner well known to those skilled in the art. The changeable face panel 32 preferably is substantially made of rigid PVC plastic. Nevertheless, the use of the prior art changeable face panel illustrated in FIG. 3 involves applying a printed sign image with adhesive to the display face 34 and at least periodically cleaning the printed image and adhesive from the display face. Further improvement in the ease of changing the images is desired.

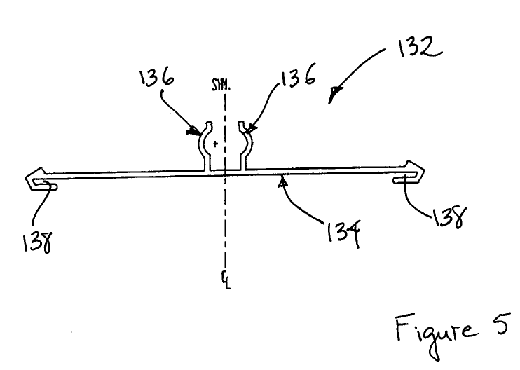

FIG. 4 is a perspective view illustrating an improved faceplate 132 according to the presently most preferred embodiment of the invention positioned adjacent to a conventional louver 14 of the type shown in FIG. 2 for being mounted to (or after being removed from) a face of the louver. FIG. 5 is a cross-section view of a faceplate 132 according to the presently most-preferred embodiment of the invention, as shown in FIG. 4. As best shown in FIG. 5, the rib 136 is preferably defined by a pair of opposed concavely bowed flanges. Preferably, the pair of bowed flanges are sufficiently flexible to snap into a slot 28a, 28b, and 28c in one of the faces 24a, 24b, and 24c of the louver 14. The faceplate 132 is preferably symmetrical as shown about a centerline.

According to one aspect of the invention, an improved faceplate 132 is provided for use in a multi-faced sign having a plurality of louvers, such as louver 14, wherein each louver 14 has a plurality of faces 24a, 24b, and 24c, and a slot 28a, 28b, and 28c, respectively, in each of the faces, the faceplate comprising: (a) a generally rectangular panel 134; (b) a rib 136 on the back side of the panel 134 adapted to engage the slot 28a, 28b, or 28c in one of the faces 24a, 24b, and 24c, respectively, of the louver 14 and retain the panel 134 on the face of the louver; and (c) a groove 138 adjacent each elongated edge of the front side of the panel 134, wherein each groove 138 is substantially parallel to the front side of the panel and the grooves open toward one another.

Continuing to refer to FIG. 4 of the drawing, according to another aspect of the invention, a louver 14 and faceplate 132 assembly are provided for use in a multi-faced sign, the assembly comprising: (a) a louver 14 having a plurality of faces 24a, 24b, and 24c and a slot 28a, 28b, and 28c, respectively, in each of the faces; (b) a faceplate 132 adapted to be mounted to the slot in one of the faces, wherein the faceplate comprises: (i) a generally rectangular panel 134; (ii) a rib 136 on the back side of the panel adapted to engage the slot in one of the faces of the louver; and (iii) a groove 138 adjacent each elongated edge of the front side of the panel, wherein each groove is substantially parallel to the front side of the panel and the grooves open toward one another (as best shown in FIG. 5).

Referring now to FIGS. 1 and 4, according a yet another aspect of the invention, a multi-faced sign 10 is provided, the sign 10 comprising: (a) a frame 12 for supporting a plurality of rotatable louvers 14; (b) each louver having a plurality of faces 24a, 24b, and 24c and a slot 28a, 28b, and 28c, respectively, in each of the faces; (c) a faceplate 132 adapted to be mounted to the slot in one of the faces, wherein the faceplate comprises: (i) a generally rectangular panel 134; (ii) a rib 136 on the back side of the panel 134 adapted to engage the slot in one of the faces of the louver; and (iii) a groove 138 adjacent each elongated edge of the front side of the panel, wherein each groove 138 is substantially parallel to the front side of the panel and the grooves open toward one another; (d) a drive system 16, as known to those of skill in the art, to rotate the plurality of louvers 14 to selectively or periodically present aligned faces for presenting aligned sections of a complete message or advertisement.

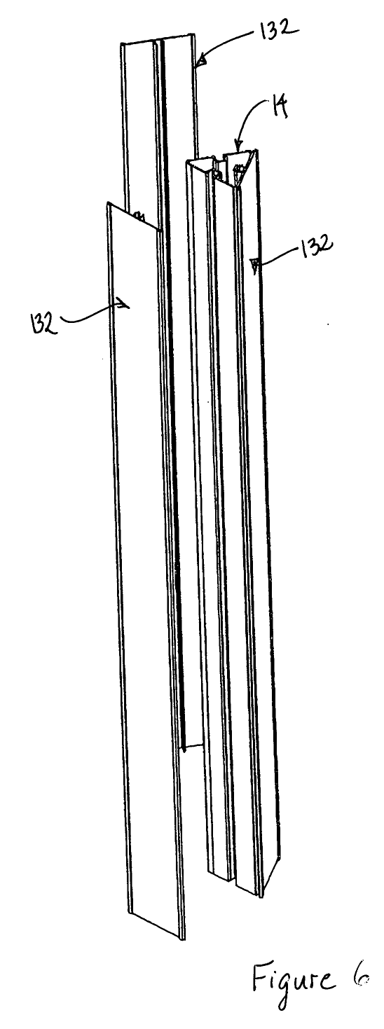

FIG. 6 is an exploded perspective view illustrating a louver 14 as shown in FIG. 2 having the improved faceplate 132 according to the presently most-preferred embodiment of the invention mounted on a face thereof and two additional faceplates 132 according to the invention oriented for attaching to the other two faces of the louver 14, respectively.

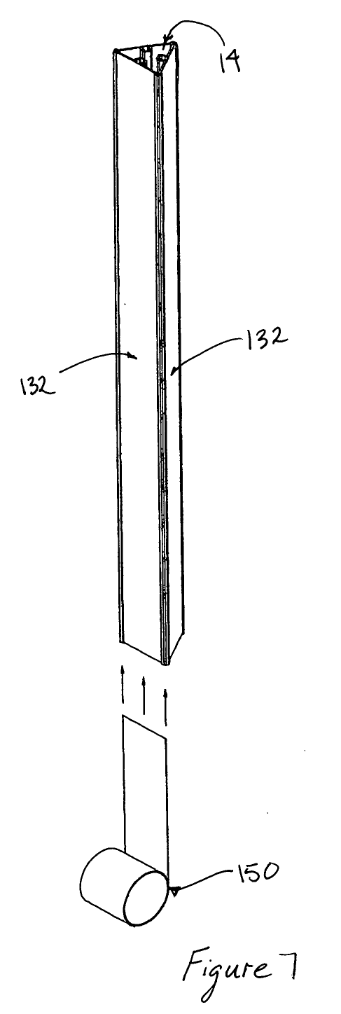

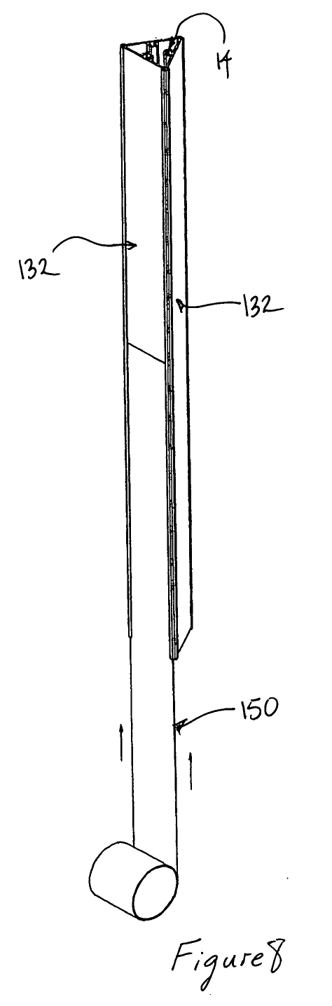

FIG. 7 is a perspective view illustrating three faceplates 132, each according to the presently most-preferred embodiment of the invention as shown in FIG. 4 having been attached to the faces of a conventional louver 14 of the type shown in FIG. 2, and further illustrating a rolled-up sheet of generally rectangular sheet material 150 positioned to be installed onto one of the faceplates according to a presently most-preferred method of the invention. FIG. 8 is a perspective view similar to FIG. 7 illustrating the rolled-up sheet of sheet material 150 being installed onto one of the faceplates according to the presently most-preferred method of the invention.

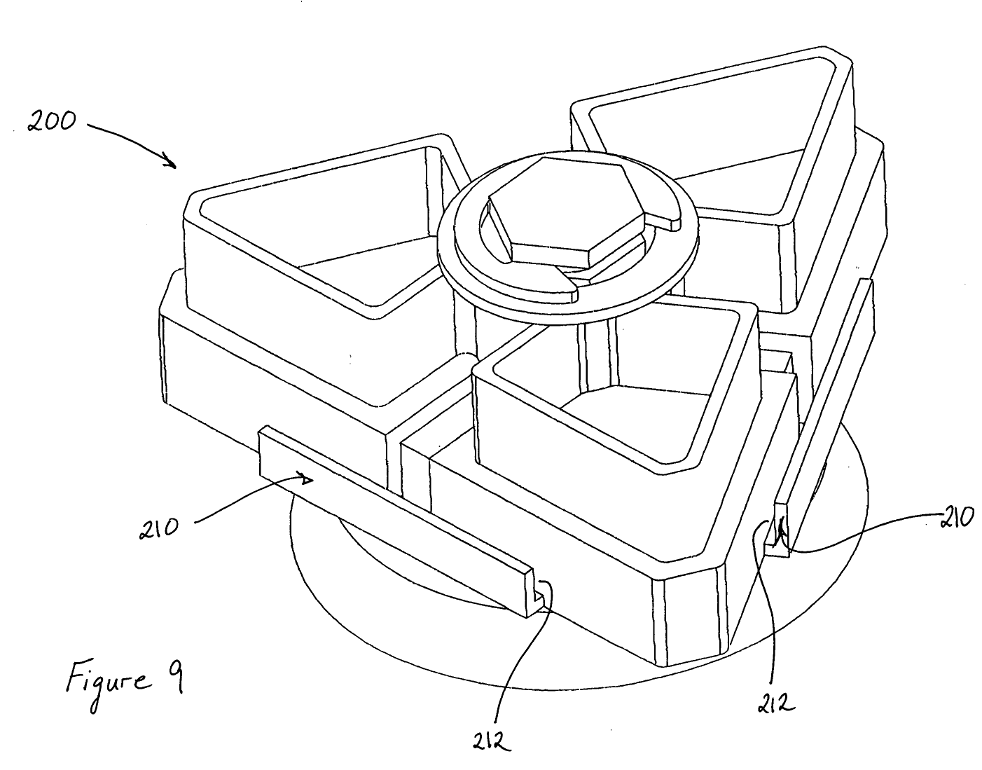

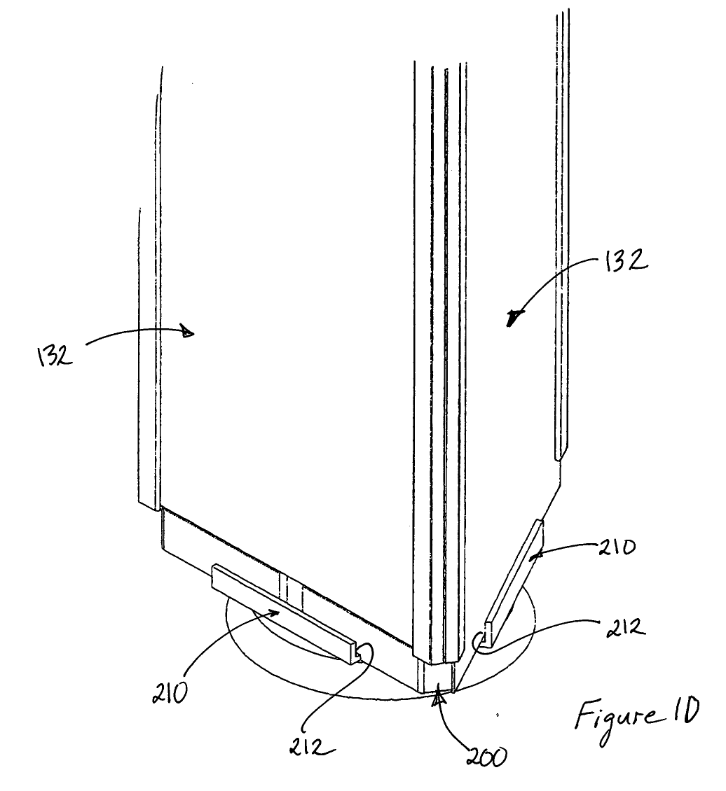

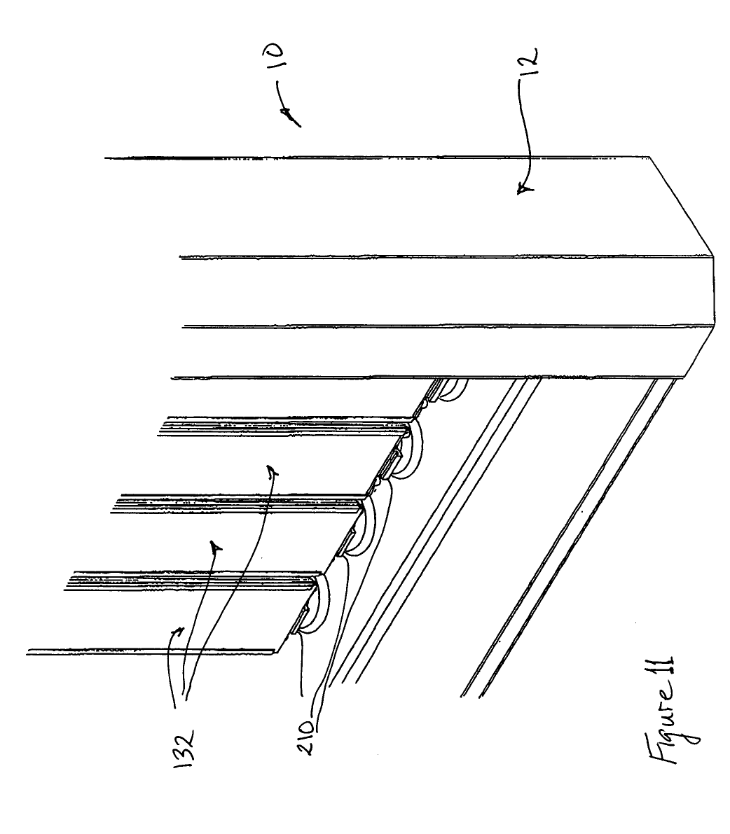

FIG. 9 is a perspective view of an endcap 200 according to the presently most-preferred embodiment of the invention, wherein the endcap 200 is provided with a lip 210 adjacent a lower edge of each side thereof to support the sheet material when a faceplate on a louver is vertically positioned, wherein the endcap 200 is shown mounted for driving rotation. Each of the lips 210 provides a groove 212 adapted to receive and support a lower edge of sheet material (not shown in FIG. 9). FIG. 10 is a perspective view of the lower end of a louver 14 according to the presently most-preferred embodiment of the invention positioned on the endcap 200 shown in FIG. 9. FIG. 11 is a perspective view of a lower, right-hand corner of a multi-faced billboard sign 10, similar to the sign 10 shown in FIG. 1, in a typical vertical orientation to the ground, similar to the sign shown in FIG. 1, illustrating the exposed lower lip 210 on each of the plurality the endcaps 210 as positioned in a sign 10 according to the invention.

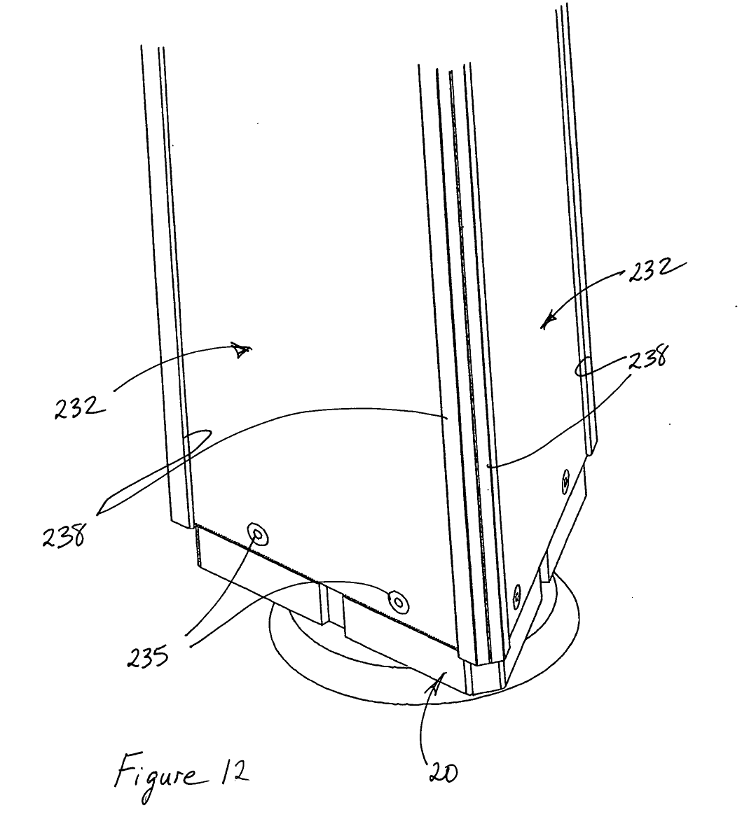

FIG. 12 is a perspective view of an alternative embodiment of a faceplate 232 according to the invention, wherein the lower edge of a faceplate 232 has at least one opening therein for use in attaching a lip structure to a lower edge of the faceplate to support a sheet material (not shown) when a faceplate 232 on a louver is vertically positioned. In this example, all that would be required to provide a lip structure would be one or more rivets 235 to provide an outwardly or forwardly protruding structure against which the sheet material can be supported. The faceplate 232 has grooves 238, as in the most-preferred embodiment shown in FIGS. 4-5.

Preferably, each louver 14 has an endcap 200, and wherein the endcap 200 further comprises: a forward extending lip 210 adjacent a shorter edge of the panel. Alternatively, the faceplate 232 can further comprise a forward extending projection or lip adjacent a shorter edge of the panel.

The elongated edges of the rectangular sheet material are constrained between the grooves 138 on the front side of the panel 134. The ideal sheet material has the properties of being: (a) bendable but relatively firm stock; (b) capable of accepting printed graphics; and (c) capable of retaining printed graphics under outdoor weather conditions. Preferably, the sheet material has the further property of being capable of retaining printed graphics under outdoor weather conditions for at least 30 days. The sheet material can be sufficiently flexible to form into rolls. Preferably, the sheet material is selected from the group consisting of: styrene and vinyl. Typically, the sheet material has graphics printed thereon.

An example of the means for attaching the panel is a rib 136 on the back side of the panel adapted to engage the slot in one of the faces of the louver and retain the panel on the face of the louver. Preferably, the means for attaching the panel is capable of being selectively removed from the louver by hand without tools. For example, preferably the rib 136 is defined by a pair of opposed concavely bowed flanges. Preferably, the pair of bowed flanges are sufficiently flexible to snap into the slot in one of the faces of the louver.

Preferably, the improved faceplate 132 or 138 is substantially made of plastic. More preferably, the plastic of the faceplate is a polyvinyl chloride (“PVC”).

According to yet another aspect of the invention, a method for adapting a multi-faced sign to selectively receive sheet material without adhesive is provided, wherein the sign has a plurality of louvers and wherein each louver has a plurality of faces and a slot in each of the faces, the method comprising the steps of: (a) attaching a faceplate according to the invention to a face of a louver; and (b) attaching a rectangular sheet material to the front side of the panel of the faceplate by inserting the elongated pair of edges of the sheet material to slide between the grooves on the front side of the panel, whereby the sheet material is constrained between the grooves on the front side of the panel.

Preferably, each louver has an endcap, and wherein the endcap further comprises: a forward extending lip adjacent a shorter edge of a face of the louver. Alternatively, for example, a method is provided wherein the faceplate further comprises: a forward extending lip or projection adjacent a shorter edge of the panel on which a short edge of the sheet material can be supported against falling down when the faceplate is in a vertical position.

Preferably, the method further comprises the step of removing the sheet material from the faceplate by sliding the elongated pair of edges of the sheet material out of the grooves on the front panel.

Preferably, the method wherein the faceplate is capable of being selectively removed from the louver by hand without tools.

The invention is described with respect to presently-preferred embodiments, but is not intended to be limited to the described embodiments. It will be readily apparent to those of ordinary skill in the art that numerous modifications may be made to the invention without departing from the scope and spirit of the invention as defined by the claims.

What is claimed is:

1. A faceplate for use in a multi-faced sign having a plurality of louvers, wherein each louver has a plurality of faces and a slot in each of the faces, the faceplate comprising:
(a) a generally rectangular panel;
(b) a rib on the back side of the panel adapted to engage the slot in one of the faces of the louver and retain the panel on the face of the louver;
(c) a groove adjacent each elongated edge of the front side of the panel, wherein each groove is substantially parallel to the front side of the panel and the grooves open toward one another.

2. The faceplate according to claim 1, wherein the faceplate further comprises: a forward extending lip adjacent a shorter edge of the panel.

3. A faceplate for use in a multi-faced sign having a plurality of louvers, wherein each louver has a plurality of faces and a slot in each of the faces, the faceplate comprising:
(a) a generally rectangular panel;
(b) a means for attaching the panel to one of the faces of one of the louvers;
(c) a groove adjacent each elongated edge of the front side of the panel, wherein each groove is substantially parallel to the front side of the panel and the grooves open toward one another.

4. The faceplate according to claim 3, wherein the faceplate further comprises: a forward extending lip adjacent a shorter edge of the panel.

5. A louver and faceplate assembly for use in a multi-faced sign, the assembly comprising:
(a) a louver having a plurality of faces and a slot in each of the faces;
(b) a faceplate adapted to be mounted to the slot in one of the faces, wherein the faceplate comprises:
(i) a generally rectangular panel;
(ii) a rib on the back side of the panel adapted to engage the slot in one of the faces of the louver;
(iii) a groove adjacent each elongated edge of the front side of the panel, wherein each groove is substantially parallel to the front side of the panel and the grooves open toward one another.

6. A louver and faceplate assembly for use in a multi-faced sign, the assembly comprising:
(a) a louver having a plurality of faces and a slot in each of the faces;
(b) a faceplate adapted to be mounted to the slot in one of the faces, wherein the faceplate comprises:
(i) a generally rectangular panel;
(ii) a means for attaching the panel to one of the faces of one of the louvers;
(iii) a groove adjacent each elongated edge of the front side of the panel,
wherein each groove is substantially parallel to the front side of the panel and the grooves open toward one another.

7. A multi-faced sign comprising:
(a) a frame for supporting a plurality of rotatable louvers;
(b) each louver having a plurality of faces and a slot in each of the faces;
(c) a faceplate adapted to be mounted to the slot in one of the faces, wherein the faceplate comprises:
(i) a generally rectangular panel;
(ii) a rib on the back side of the panel adapted to engage the slot in one of the faces of the louver;
(iii) a groove adjacent each elongated edge of the front side of the panel, wherein each groove is substantially parallel to the front side of the panel and the grooves open toward one another;
(d) a drive system to rotate the plurality of louvers to selectively or periodically present aligned faces for presenting aligned sections of a complete message or advertisement.

8. A multi-faced sign comprising:
(a) a frame for supporting a plurality of rotatable louvers;
(b) each louver having a plurality of faces and a slot in each of the faces;
(c) a faceplate adapted to be mounted to the slot in one of the faces, wherein the faceplate comprises:
(i) a generally rectangular panel;
(ii) a means for attaching the panel to one of the faces of one of the louvers;
(iii) a groove adjacent each elongated edge of the front side of the panel, wherein each groove is substantially parallel to the front side of the panel and the grooves open toward one another;
(d) a drive system to rotate the plurality of louvers to selectively or periodically present aligned faces for presenting aligned sections of a complete message or advertisement.

9. The sign according to any one of claims 7-8, wherein each louver has an endcap, and wherein the endcap further comprises: a forward extending lip adjacent a shorter edge of the panel.

10. The sign according to any one of claims 7-8, further comprising a rectangular sheet material, whereby the elongated edges of the rectangular sheet material are constrained between the grooves on the front side of the panel.

11. The sign according to claim 10, wherein the sheet material has the properties of being: (a) bendable but relatively firm stock; (b) capable of accepting printed graphics; and (c) capable of retaining printed graphics under outdoor weather conditions.

12. The sign according to claim 11, wherein the sheet material has the further property of being capable of retaining printed graphics under outdoor weather conditions for at least 30 days.

13. The sign according to claim 10, wherein the sheet material is selected from the group consisting of: styrene and vinyl.

14. The sign according to claim 10, wherein the sheet material has graphics printed thereon.

15. The sign according to any one of claims 7-8, wherein the slot in is centrally located in each face of the louver.

16. The sign according to any one of claims 7-8, wherein the rib is defined by a pair of opposed concavely bowed flanges.

17. The sign according to claim 16, wherein the pair of bowed flanges are sufficiently flexible to snap into the slot in one of the faces of the louver.

18. The sign according to claim 8, wherein the means for attaching the panel is capable of being selectively removed from the louver by hand without tools.

19. The sign according to claim 8, wherein the means for attaching the panel is a rib on the back side of the panel adapted to engage the slot in one of the faces of the louver and retain the panel on the face of the louver.

20. The sign according to claim 19, wherein the rib is defined by a pair of opposed concavely bowed flanges.

21. The sign according to claim 20, wherein the pair of bowed flanges are sufficiently flexible to snap into the slot in one of the faces of the louver.

22. The sign according to any one of claims 7-8, wherein a forwardly bent over lip portion of each elongated edge of the panel defines each elongated groove.

23. The sign according to any one of claims 7-8, wherein each of the louvers is a generally triangular prism with three faces.

24. The sign according to any one of claims 7-8, wherein the faceplate is substantially made of plastic.

25. The sign according to claim 24, wherein the plastic is a polyvinyl chloride (“PVC”).

26. A method for adapting a multi-faced sign to selectively receive sheet material without adhesive, wherein the sign has a plurality of louvers and wherein each louver has a plurality of faces and a slot in each of the faces, the method comprising the steps of:
(a) attaching a faceplate to one of the faces of one of the louvers, the faceplate comprising:
(i) a generally rectangular panel;
(ii) a rib on the back side of the panel adapted to engage the slot in one of the faces of the louver and retain the panel on the face of the louver;
(iii) a groove adjacent each elongated edge of the front side of the panel, wherein each groove is substantially parallel to the front side of the panel and the grooves open toward one another;
(b) attaching a rectangular sheet material to the front side of the panel of the faceplate by inserting the elongated pair of edges of the sheet material to slide between the grooves on the front side of the panel, whereby the sheet material is constrained between the grooves on the front side of the panel.

27. The method according to claim 26, wherein each louver has an endcap, and wherein the endcap further comprises: a forward extending lip adjacent a shorter edge of a face of the louver.

28. The method according to claim 26, wherein the faceplate further comprises: a forward extending lip adjacent a shorter edge of the panel on which a short edge of the sheet material can be supported against falling down when the faceplate is in a vertical position.

29. A method for adapting a multi-faced sign to selectively receive sheet material without adhesive, wherein the sign has a plurality of louvers and wherein each louver has a plurality of faces and a slot in each of the faces, the method comprising the steps of:
(a) attaching a faceplate to one of the faces of one of the louvers, the faceplate comprising:
(i) a generally rectangular panel;
(ii) a means for attaching the panel to one of the faces of one of the louvers;
(iii) a groove adjacent each elongated edge of the front side of the panel, wherein each groove is substantially parallel to the front side of the panel and the grooves open toward one another;
(b) positioning a rectangular sheet material on the front side of the panel of the faceplate by inserting the elongated pair of edges of the sheet material to slide between the grooves on the front side of the panel, whereby the sheet material is constrained between the grooves on the front side of the panel.

30. The method according to claim 29, wherein each louver has an endcap, and wherein the endcap further comprises: a forward extending lip adjacent a shorter edge of a face of the louver.

31. The method according to claim 29, wherein the faceplate further comprises: a forward extending lip adjacent a shorter edge of the panel on which a short edge of the rectangular sheet material can be supported against falling down when the faceplate is in a vertical position.

32. The method according to any one of claims 26 and 29, further comprising the step of: removing the sheet material from the faceplate by sliding the elongated pair of edges of the sheet material out of the grooves on the front panel.

33. The method according to any one of claims 26 and 29, wherein the sheet material has the properties of being: (a) bendable but relatively firm stock; (b) capable of accepting printed graphics; and (c) capable of retaining printed graphics under outdoor weather conditions.

34. The method according to claim 33, wherein the sheet material has the further property of being capable of retaining printed graphics under outdoor weather conditions for at least 30 days.

35. The method according to any one of claims 26 and 29, wherein the sheet material is selected from the group consisting of: styrene and vinyl.

36. The method according to any one of claims 26 and 29, wherein the rectangular sheet material has graphics printed thereon.

37. The method according to any one of claims 26 and 29, wherein the slot in is centrally located in each face of the louver.

38. The method according to claim 26, wherein the rib is defined by a pair of opposed concavely bowed flanges.

39. The method according to claim 38, wherein the pair of bowed flanges are sufficiently flexible to snap into the slot in one of the faces of the louver.

40. The method according to claim 29, wherein the means for attaching the panel is capable of being selectively removed from the louver by hand without tools.

41. The method according to claim 29, wherein the means for attaching the panel is a rib on the back side of the panel adapted to engage the slot in one of the faces of the louver and retain the panel on the face of the louver.

42. The method according to claim 41, wherein the rib is defined by a pair of opposed concavely bowed flanges.

43. The method according to claim 42, wherein the pair of bowed flanges are sufficiently flexible to snap into the slot in one of the faces of the louver.

44. The method according to any one of claims 26 and 29, wherein a forwardly bent over lip portion of each elongated edge of the panel defines each elongated groove.

45. The method according to any one of claims 26 and 29, wherein each of the louvers is a generally triangular prism with three faces.

46. The method according to any one of claims 26 and 29, wherein the faceplate is substantially made of plastic.

47. The method according to claim 46, wherein the plastic is a polyvinyl chloride (“PVC”).
